(19) United States
(12) Patent Application Publication
(10) Pub. No.: US 2021/0361399 A1
(43) Pub. Date: Nov. 25, 2021

(54) PUMP UNIT WITH INTEGRATED VALVES

(71) Applicant: KONINKLIJKE PHILIPS N.V., EINDHOVEN (NL)

(72) Inventors: Joldert Maria BOERSMA, Zuidhorn (NL); Klaas KOOIJKER, Drachten (NL); Aaldert Geert ZIJLSTRA, Zuidlaren (NL); Desalegn GEBRESILASSIE, Drachten (NL); Egbert VAN DE VEEN, Ijsselmuiden (NL)

(21) Appl. No.: 16/765,072

(22) PCT Filed: Nov. 21, 2018
(86) PCT No.: PCT/EP2018/082019

§ 371 Date: May 18, 2020

Related U.S. Application Data
(60) Provisional application No. 62/591,342, filed on Nov. 28, 2017.

(51) Int. Cl. A61C 17/02; F04B 53/10; F04B 53/16; F16K 15/16

(52) U.S. Cl. CPC A61C 17/0202; F16K 15/16; F04B 53/16; F04B 53/10

(57) ABSTRACT

A valve assembly (10) including first and second housing parts (22, 24). The first and second housing parts are secured to each other such that respective channels in each are aligned to define inlet and outlet fluid pathways (25, 35) through the valve assembly. A leaf valve insert (38) is arranged between the first and second housing parts, and includes a plurality of leaves (40). First and second leaves are respectively aligned with the inlet and outlet fluid pathways. The first leaf (40a) is configured to permit fluid flow in the inlet fluid pathway in a first direction while impeding fluid flow in a second direction. The second leaf (40b) is configured to permit fluid flow in the outlet fluid pathway in the second direction while impeding fluid flow in the first direction. The first direction is from the first housing part toward the second, and the second direction is from the second housing part toward the first.

### FIELD OF THE INVENTION

The present disclosure is directed generally to pump units and valve assemblies for pump units.

### BACKGROUND

Pumps and valve assemblies in general are used in a variety of applications, including household consumer goods and electronic devices. For example, many commercially available oral irrigators (and other personal cleaning devices) use a piston pump for delivering flow and pressure needed to perform its intended function, e.g., cleaning teeth. These types of pumps must have valves to operate properly. Typically there are at least an inlet valve and an outlet valve. When the piston of the pump is moving backwards, it draws water into the piston cylinder. During this stroke the inlet valve opens, allowing fresh water from the reservoir into the cylinder, and the outlet valve is closed, preventing water from back flowing through the outlet channel. After this stroke, the piston moves forward to push the water through the outlet channel. During this stroke the outlet valve is open and the inlet valve is closed.

Typically the pump and the valves are separate parts that are assembled together in the final device. However, each valve requires a separate subassembly that must be individually put together, installed into the final device, and sealed. This results in a relatively increased number of components and complexity, and therefore increased assembly time and cost.

Accordingly, there is a continued need in the art, particularly with respect to consumer goods, to decrease cost and assembly time without sacrificing performance or quality.

### SUMMARY OF THE INVENTION

The present disclosure is directed to inventive apparatuses including pump units and valve assemblies for pump units. Various embodiments and implementations herein are directed to a valve assembly having a leaf valve insert positioned at an interface between two housing parts. The leaf valve insert includes a plurality of leaves, each of which is aligned with a different channel or fluid flow pathway in the valve assembly to selectively impede fluid flow through the respective fluid pathway. The valve assembly may be part of a pump unit coupled to a pump assembly having a pressure chamber in fluid communication with an inlet fluid pathway and an outlet fluid pathway. Flow through the inlet fluid pathway and the outlet fluid pathway is selectively impeded by corresponding first and second leaves. Fluid flow in the inlet fluid pathway is permitted past the first leaf in a first direction toward the pressure chamber but impeded in a second direction opposite to the first direction. Similarly, fluid flow in the outlet fluid pathway is permitted past the second leaf in the second direction away from the pressure chamber but impeded in the first direction.

Generally, in one aspect, a valve assembly is provided. The valve assembly includes a first housing part having a first inlet channel and a first outlet channel formed therein; a second housing part having a second inlet channel and a second outlet channel formed therein, the first and second housing parts are secured to each other such that the first inlet channel and the second inlet channel are aligned to define an inlet fluid pathway through the valve assembly, and the first outlet channel and the second outlet channel are aligned to define an outlet fluid pathway through the valve assembly; and a leaf valve insert arranged at an interface between the first housing part and the second housing part, the leaf valve insert including a base having a plurality of leaves hingedly connected thereto, the plurality of leaves including a first leaf aligned with the inlet fluid pathway and a second leaf aligned with the outlet fluid pathway; wherein the first leaf is operatively configured to permit fluid flow in the inlet fluid pathway past the first leaf in a first direction while impeding fluid flow through the inlet fluid pathway in a second direction, and the second leaf is operatively configured to permit fluid flow in the outlet fluid pathway past the second leaf in the second direction while impeding fluid flow in the outlet fluid pathway in the first direction, wherein the first direction is generally directed from the first housing part toward the second housing part and the second direction is generally directed from the second housing part toward the first housing part.

In accordance with an embodiment, the leaf valve insert is formed from a single sheet of material.

In accordance with an embodiment, the leaf valve insert further comprises a third leaf and the valve assembly includes a pressure relief subassembly selectively impeded by the third leaf. In a further embodiment, the pressure relief subassembly further comprises a biasing member engaged against the third leaf that sets a threshold pressure for opening the third leaf. In another embodiment, the pressure relief subassembly further comprises an adjuster plug that is movable with respect to the biasing member to set a spring force exerted by the biasing member on the third leaf. In yet another embodiment, the biasing member is located in a relief chamber and the third leaf permits fluid communication with the relief chamber when the third leaf is opened, and the relief chamber is in fluid communication with the first inlet channel of the first housing part.

In accordance with an embodiment, the base of the leaf valve insert comprises an outer ring or a central hub from which the plurality of leaves extends. In accordance with an embodiment, the first housing part includes a first recess to receive the second leaf when the second leaf is opened and the second housing part includes a second recess to receive the first leaf when the first leaf is opened.

In accordance with one aspect, a pump unit is provided that includes a valve assembly according to an embodiment disclosed herein, wherein the valve assembly is coupled to a pump assembly.

In an embodiment, the pump assembly includes a pressure chamber in fluid communication with both the inlet fluid pathway and the outlet fluid pathway. In a further embodiment a single seal is included between the first housing part and the second housing part to seal the inlet fluid pathway, the outlet fluid pathway, and the pressure chamber.

In an embodiment, the pump assembly comprises a piston that is reciprocal within a cylinder to pull fluid into the pressure chamber via the inlet fluid pathway and pump fluid out of the pressure chamber via the outlet fluid pathway. In a further embodiment, the cylinder is integrally formed with the second housing part and the pressure chamber is defined at least partially by the cylinder and the second housing part.

In accordance with one aspect, an oral care device is provided that comprises a pump unit according to an embodiment disclosed herein, wherein the oral care device includes a reservoir and a cleaning nozzle, the reservoir is in fluid communication with the inlet fluid pathway of the valve assembly to supply fluid to the pressure chamber, and the cleaning nozzle is in fluid communication with the outlet fluid pathway such that pressurized fluid pumped by the pump unit is emitted out of the cleaning nozzle.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a perspective view of a pump unit having a valve assembly according to one embodiment discussed herein.

FIG. 2 is an exploded view of the components of the valve assembly of the pump unit of FIG. 1.

FIG. 3 is an exploded view of the components of the valve assembly of the pump unit of FIG. 1 from a different perspective than FIG. 2.

FIG. 4 is a perspective view of some of the components of the pump unit of FIG. 1, primarily showing a leaf valve insert.

FIG. 5 is a cross-sectional view of the pump unit of FIG. 1 taken generally along line 5-5 in FIG. 1 and corresponding to the line 5′-5′ in FIG. 4.

FIG. 6 is an enlarged view of the encircled area indicated in FIG. 5.

FIG. 7 is a cross-sectional view of the pump unit of FIG. 1 taken generally along line 7-7 in FIG. 1 and corresponding to the line 7′-7′ in FIG. 4.

FIGS. 8A-8D are leaf valve inserts according to various embodiments disclosed herein.

FIG. 9 is a cross-sectional view of a pump unit according to one embodiment disclosed herein having a valve assembly oriented differently than that in the embodiment of FIG. 1.

FIG. 10 is a cross-sectional view of a valve assembly according to one embodiment disclosed herein having a pressure relief subassembly different than that in the embodiment of FIG. 1.

FIG. 11 is a schematic view of an oral care device including a pump unit according to an embodiment of FIG. 1.

### DETAILED DESCRIPTION OF EMBODIMENTS

The present disclosure describes various embodiments of a valve assembly and a pump unit. More generally, Applicant has recognized and appreciated that it would be beneficial to provide a valve assembly with a leaf valve insert that includes a first leaf for selectively impeding an inlet fluid pathway through the valve assembly and a second leaf for selectively impeding an outlet fluid pathway through the valve assembly. A particular goal of utilization of certain embodiments of the present disclosure is to create a valve assembly for a pump unit that is compact, has relatively few components, and is easy to assemble in comparison to currently known valve assemblies and pump units.

In view of the foregoing, various embodiments and implementations are directed to a valve assembly having a leaf valve insert positioned at an interface between two housing parts. The leaf valve insert includes a plurality of leaves, each of which is aligned with a different channel or fluid flow pathway in the valve assembly to selectively impede fluid flow through the respective fluid pathway. The valve assembly may be part of a pump unit coupled to a pump assembly having a pressure chamber in fluid communication with an inlet fluid pathway and an outlet fluid pathway. Flow through the inlet fluid pathway and the outlet fluid pathway is selectively impeded by corresponding first and second leaves. Fluid flow in the inlet fluid pathway is permitted past the first leaf in a first direction toward the pressure chamber but impeded in a second direction opposite to the first direction. Similarly, fluid flow in the outlet fluid pathway is permitted past the second leaf in the second direction away from the pressure chamber but impeded in the first direction.

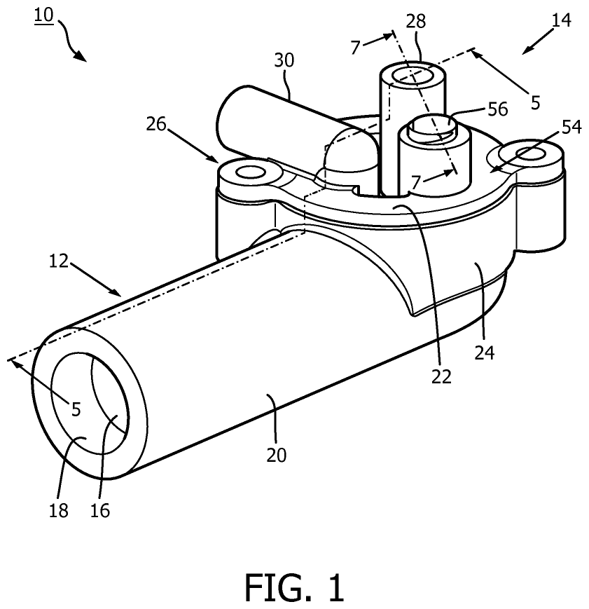

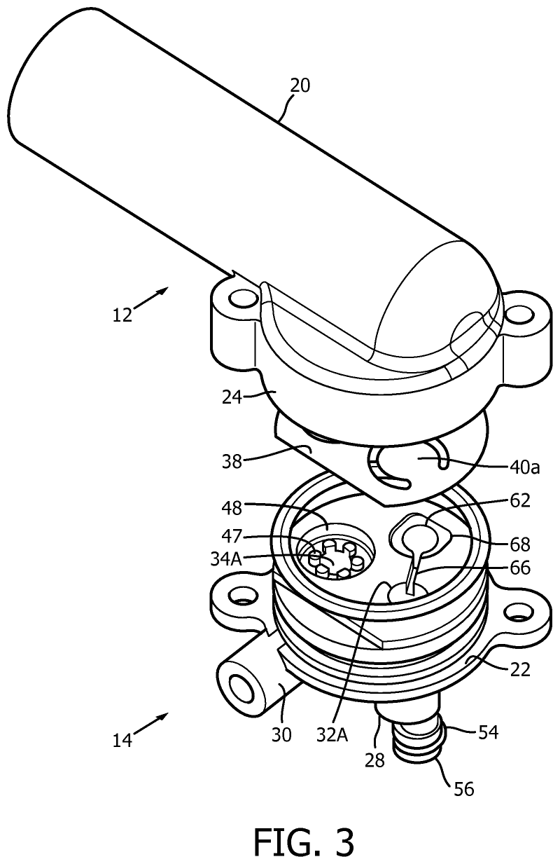

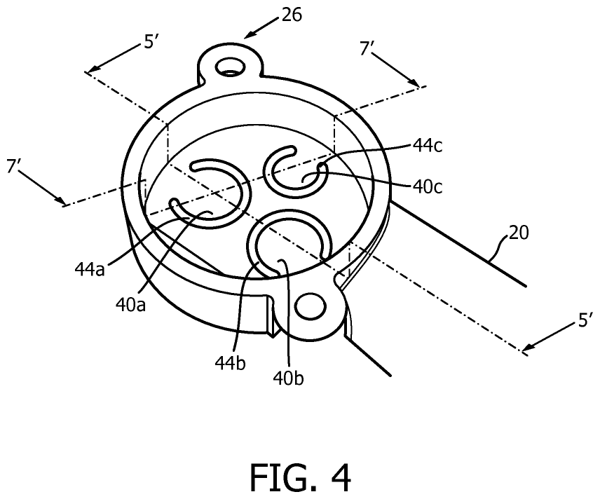

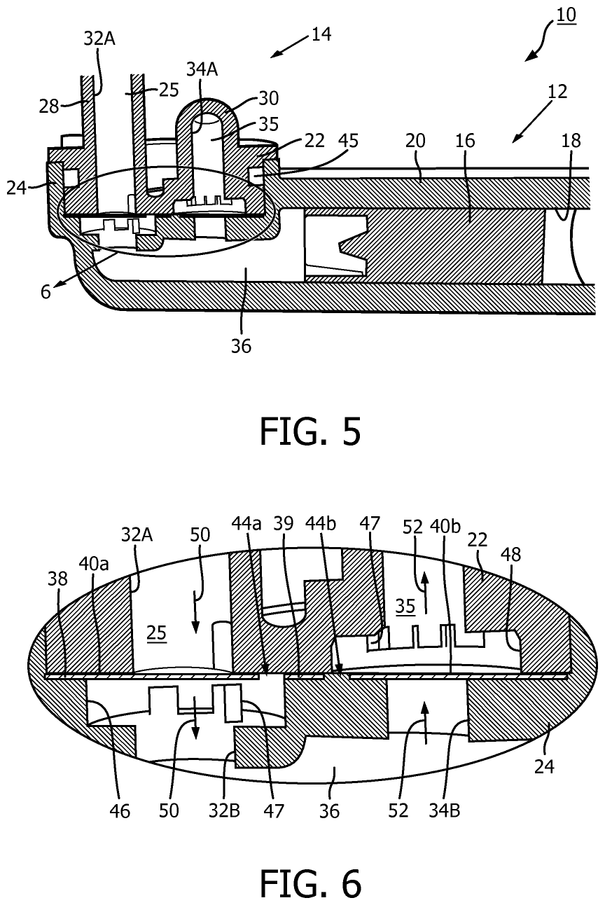

Referring to FIGS. 1-7, in one embodiment, a pump unit 10 is provided with a pump assembly 12 and a valve assembly 14. In an embodiment of FIG. 1, the pump assembly 12 includes a piston 16 that is reciprocal within a piston chamber 18 of a cylinder 20 to pressurize a pumped fluid. The valve assembly 14 includes a first housing part 22 secured to a second housing part 24, e.g., at attachment points 26. The valve assembly 14 also includes an inlet 28 that provides a flow of fluid through an inlet fluid pathway 25 (shown in FIGS. 5-6) to the pump assembly 12 and an outlet 30 that directs pressurized fluid away from the pump assembly 12 through an outlet fluid pathway 35 (shown in FIGS. 5-6). Referring to FIGS. 5 and 6, the inlet fluid pathway 25 is defined by an inlet channel 32A formed through the first housing part 22 and an inlet channel 32B formed through the second housing part 24 and aligned with the inlet channel 32A. The outlet fluid pathway 35 is similarly defined by an outlet channel 34A formed through the first housing part 22 and an outlet channel 34B formed through the second housing part 24 and aligned with the outlet channel 34B.

It is to be appreciated that the pump assembly 12 is provided as just one example and that the valve assembly 14 may be used with other pumps or different types of devices in which fluid flow control is desired. Notably, the valve assembly 14 is particularly advantageous for other positive displacement pumps which have a common fluid chamber (i.e., akin to the chamber 36) for both an inlet and an outlet.

In the illustrated embodiment, the attachment points 26 are illustrated as protrusions having bores formed therein arranged to receive screws, bolts, rivets, or other fasteners (not shown). However, it is to be understood that the first housing part 22 may be connected to the second housing part 24 in any desired manner, e.g., a threaded connection, interference fit, snaps or ratchets, welds, adhesives, etc. It is additionally noted that while the cylinder 20 of the pump assembly 12 is shown in the illustrated embodiments as integrally formed with the second housing part 24, that those of ordinary skill in the art will understand that in other embodiments the cylinder 20 may be connected or coupled to the valve assembly 14 in another manner, e.g., via screws, bolts, rivets, threaded connection, interference fit, snaps or ratchets, welds, adhesives, etc.

As can be best appreciated in view of the cross-sectional views of FIGS. 5-7, the fluid pathways 25 and 35 are both in fluid communication with a pressure chamber 36 of the pump assembly 12. In operation of the pump assembly 12, the pressure chamber 36 is filled with a fluid supplied via the inlet fluid pathway 25 from the inlet 28. Movement of the piston 16 within the piston chamber 18 toward the pressure chamber 36 causes pressurization of the fluid in the pressure chamber 36, which results in fluid in the chamber 36 being forced out of the pressure chamber 36 through the outlet 30 via the outlet fluid pathway 35. After pumping fluid out of the outlet 30, the chamber 36 can be refilled with fluid as the piston 16 moves away from the chamber 36 and the cycle repeated by reciprocating the piston 16 in the piston chamber 18 to repeatedly refill and then pump fluid from the chamber 36.

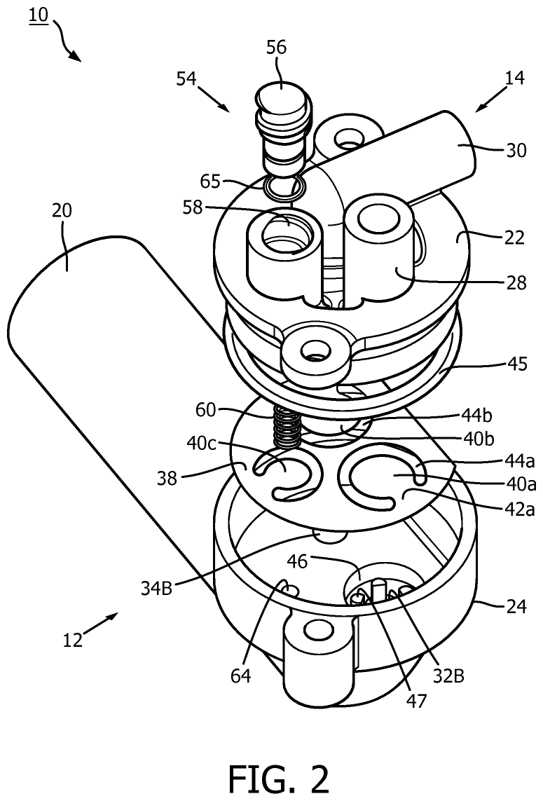

As can be best appreciated in view of FIGS. 2-6, a leaf valve insert 38 is located at the interface between the first housing part 22 and the second housing part 24. The leaf valve insert 38 includes a base 39 from which a plurality of flaps or leaves 40a, 40b, and 40c are connected to the base 39 by respective hinges 42a, 42b, and 42c and defined by respective through-cuts 44a, 44b, and 44c. It is noted that the reference numeral ‘40’ for each of the leaves, ‘42’ for each of the hinges, and ‘44’ for each of the through-cuts is appended with an alphabetic suffix (e.g., a, b, c, etc.) to facilitate discussion with respect to certain ones of the leaves, hinges, and through-cuts, however, it is to be understood that reference to the “leaves 40” is generally applicable to any or all of the leaves, “hinges 42” to any or all of the hinges, and/or “through-cuts 44” to any or all of the through-cuts, regardless of alphabetic suffix, unless otherwise noted. Advantageously, including the leaf valve insert 38 enables a single seal 45 arranged between the first housing part 22 and the second housing part 24 to seal the chamber 36, the inlet fluid pathway 25 and the outlet fluid pathway 35 as opposed to separate seals for each fluid chamber or pathway. The seal 45 may be an o-ring or any other suitable sealing element.

Each of the leaves 40 is positioned along a different fluid pathway to control the flow of fluid through the valve assembly 14. That is, the leaf 40a is located along the inlet fluid pathway 25 at the interface between the first housing part 22 and the second housing part 24 to separate the inlet channel 32A in the first housing part 22 from the inlet channel 32B in the second housing part 24. Likewise, the leaf 40b is located along the outlet fluid pathway 35 at the interface between the first housing part 22 and the second housing part 24 to separate the outlet channel 34A in the first housing part 22 from the outlet channel 34B in the second housing part 24.

Alternatively stated, in an illustrated embodiment, the leaf 40a is positioned to selectively impede fluid flow in the inlet fluid pathway 25, while the leaf 40b is positioned to selectively impede fluid flow in the outlet fluid pathway 35. By “selectively impede” it is meant that the leaves are generally arranged as one-way valves that block, hinder, or otherwise reduce flow in one direction, while substantially permitting flow in the opposite direction. In this way, the leaf 40a may be considered as the operating component of an inlet valve (i.e., a valve for controlling the flow of fluid from the inlet 28 into the chamber 36) and the leaf 40b may be considered as the operating component of an outlet valve (i.e., a valve for controlling the flow of fluid to the outlet 30 from the chamber 36).

The second housing part 24 includes a recess 46 aligned with the leaf 40a and the first housing part 22 includes a recess 48 aligned with the leaf 40b. The recess 46 provides a space into which the leaf 40a can flexibly rotate, via its hinge 42a, when the leaf 40a is in an open position or configuration to connect the inlet channels 32A and 32B and permit fluid flow through the inlet fluid pathway 25 past the leaf 40a. Similarly, the recess 48 provides a space into which the leaf 40b can flexibly rotate, via its hinge 42b, when the leaf 40b is in an open position or configuration to connect the outlet channels 34A and 34B and permit fluid flow through the outlet fluid pathway 35 past the leaf 40b. The recesses 46 and 48 may respectively include one or more delimiters 47 to limit how much the leaves can rotate into their respective recesses, e.g., to reduce the possibility of the leaves over rotating and fatiguing or plastically deforming, which may impact their ability to operate effectively.

When fluid is no longer flowing past the respective leaf, each of the leaves 40 are arranged to resiliently return (i.e., in an elastic or spring-like manner) into their naturally closed position or configuration, which is shown in the drawings. That is, when closed, the leaf 40a returns into engagement against the surface of the first housing part 22 to block fluid flow from the chamber 36 and the inlet channel 32B from entering the inlet channel 32A. Similarly, when closed the leaf 40b returns into engagement against the surface of the second housing part 24 to block fluid flow from the outlet channel 34A into the outlet channel 34B and the chamber 36. In this way, the leaves 40 selectively impede fluid flow to ensure fluid flows in from the inlet 28 and out to the outlet 30, which in turn enables the pump assembly 12 to operate properly. It is to be appreciated that the hinges 42 may be made from any desired material that exhibits suitable resiliency to endure repeated flexing between the above-described open and closed configurations.

Arrows are included in FIG. 6 to indicate the direction of flow permitted by the leaves 40a and 40b. Arrows 50 in FIG. 6 indicate the direction of fluid flow in the inlet fluid pathway 25 permitted by the leaf 40a, i.e., in a direction generally toward the chamber 36 and/or from the first housing part 22 toward the second housing part 24. Arrows 52 indicate the direction of fluid flow in the outlet fluid pathway 35 permitted by the leaf 40b, i.e., in a direction opposite to the arrows 50 directed generally away from the chamber 36 and/or from the second housing part 24 toward the first housing part 22. Due to the leaf 40a sitting flush against the surface of the first housing part 22 at the interface between the first and second housing parts, and the leaf 40b sitting flush against the opposing surface of the second housing part 24, the leaves 40a and 40b respectively block fluid flow through the fluid pathways 25 and 35 in the directions opposite to those indicated by the arrows 50 and 52.

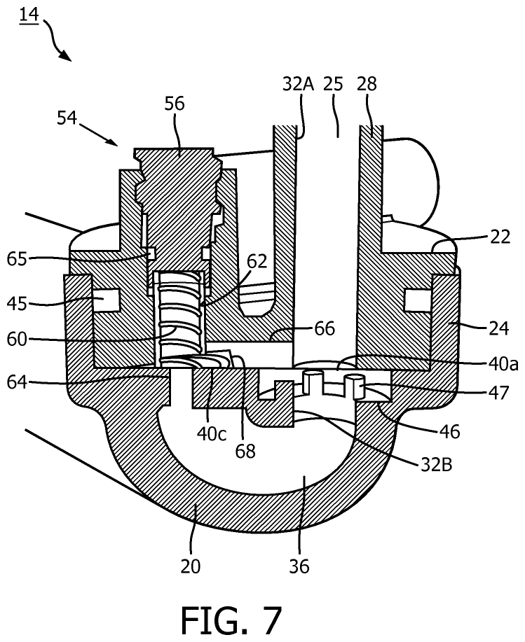

In addition to the inlet 28 and the outlet 30 the valve assembly 14 may additionally include a pressure relief subassembly 54. In the embodiments of FIGS. 1-3 and 7, the pressure relief subassembly 54 includes an adjuster plug 56, which may be coupled to the first housing part 22 via a threaded connection 58. As can be best seen in FIG. 7, the adjuster plug 56 is arranged to engage against a biasing member, or spring 60 in a relief chamber 62. The spring 60 is also engaged against the leaf 40c to maintain the leaf 40c in a closed position to impede fluid flow through a channel 64 in the second housing part 24 that is in fluid communication with the pressure chamber 36. It is to be appreciated that other biasing members in lieu of the spring 60, may be used in other embodiments, such as a resilient piece of foam, or other component capable of resiliently exerting a biasing or spring force. In order to prevent leaking of the relief chamber 62 via the threaded connection of the adjuster plug 56, a seal 65 may be included.

By use of the spring 60, the leaf 40c only transitions to its open position if the spring force exerted by the spring 60 is exceeded by the pressure exerted against the leaf 40c by fluid within the chamber 36. By moving the adjuster plug 56 in and out with respect to the relief chamber 62 and the first housing part 22 (i.e., via the threaded connection), the compression of the spring 60, and therefore the force exerted by the spring 60, can be adjusted. In this way, the pressure relief subassembly 54 can be used to set or provide a threshold pressure for the chamber 36 that corresponds to the spring force exerted by the spring 60. If the threshold pressure is exceeded in the chamber 36, the leaf 40c will open and excess fluid will be relieved from the chamber 36 through the channel 64 into the relief chamber 62. A channel 66 connects the relief chamber 62 to the inlet channel 32A to redirect the fluid back into the inlet fluid pathway 25, where it can be drawn back into the chamber 36 during a subsequent piston cycle.

It is noted that the first housing part 22 may include a recess 68 into which the leaf 40c rotates when the leaf 40c is in its open position. Unlike the recesses 46 and 48, the recess 68 in the illustrated embodiment does not include any of the delimiters 47. Instead, the recess 68 is tapered at an angle that corresponds to the angle of the leaf 40c when it is opened, thereby providing a surface against which the leaf 40c may engage to prevent over rotation, similar to the use of the delimiters 47. It is noted that instead of the recess 68 being tapered, it could include delimiters such as the delimiters 47. Additionally, it is noted that instead of including the delimiters 47, the recesses 46 and 48 may be tapered in a similar manner to the recess 68.

In one embodiment, the leaf valve insert 38, the base 39, and the leaves 40 are formed integrally from a single sheet of material. In other embodiments, the base 39, leaves 40, and hinges 42 may be made from combinations of different materials that are coupled together (e.g., bonded, welded, adhered, fastened, etc.). Those of ordinary skill in the art will recognize that the leaf valve insert 38, or at least the hinges 42, can be made from any suitably flexible and resilient material, e.g., various metals and plastics, which enables the leaves 40 to resiliently rotate between their corresponding open and closed positions.

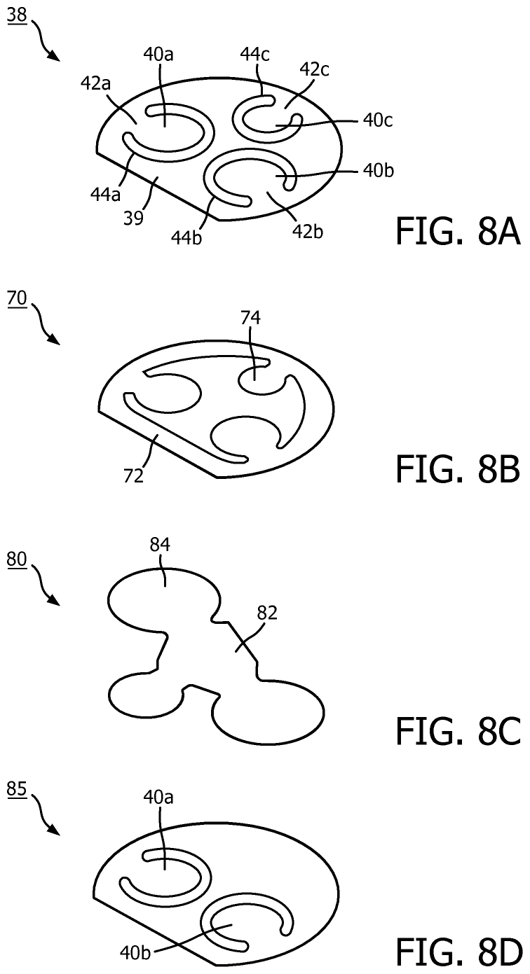

FIGS. 8A-8D illustrate leaf valve inserts according to various embodiments. FIG. 8A illustrates the leaf valve insert 38 discussed above. FIG. 8B illustrates a leaf valve insert 70 having a base 72 that is formed as an outer ring from which a plurality of leaves 74 extend. FIG. 8C illustrates a leaf valve insert 80 having a base 82 that is formed as a central hub from which a plurality of leaves 84 extend. FIG. 8D illustrates a leaf valve insert 85, which includes the leaves 40a and 40b, but not the leaf 40c and is thus suitable for embodiments which do not include a pressure relief subassembly. It is to be appreciated that any number of additional leaves may be included in other embodiments, and that the shape and layout of the base and/or the leaves can vary to accommodate any desired geometry.

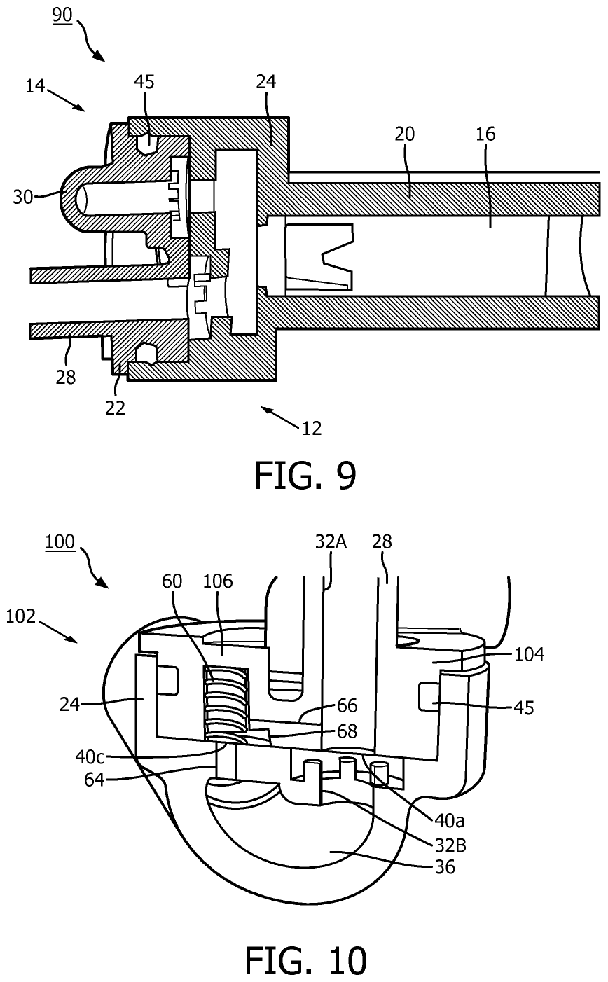

Other variations to the embodiments illustrated in FIGS. 1-7 should also be appreciated. For example, FIG. 9 illustrates a cross-section of a pump unit 90 in which the valve assembly 14 is arranged in a different orientation with respect to the pump assembly 12 than that shown with respect to the pump unit 10. FIG. 10 illustrates a cross-sectional view of a valve assembly 100, similar to the view of the valve assembly 14 in FIG. 7. Unlike the valve assembly 14, the valve assembly 100 includes a relief pressure subassembly 102 that does not include the adjuster plug 56 and a first housing part 104 that does not include the threaded connection 58, but otherwise resembles the first housing part 24. Instead, the biasing member 60 of the subassembly 102 abuts against a wall 106 of the first housing part 104, which sets a constant, non-adjustable threshold pressure for the subassembly 102. Those of ordinary skill in the art will appreciate other arrangements and orientations of the various components of the units and assemblies disclosed herein.

The embodiments and implementations disclosed or otherwise envisioned herein can be utilized with a variety of fluid pumping devices, including but not limited to an oral irrigator, a wound cleaning device, skin cleaning device, or any other device that requires the control of a flow of fluid.

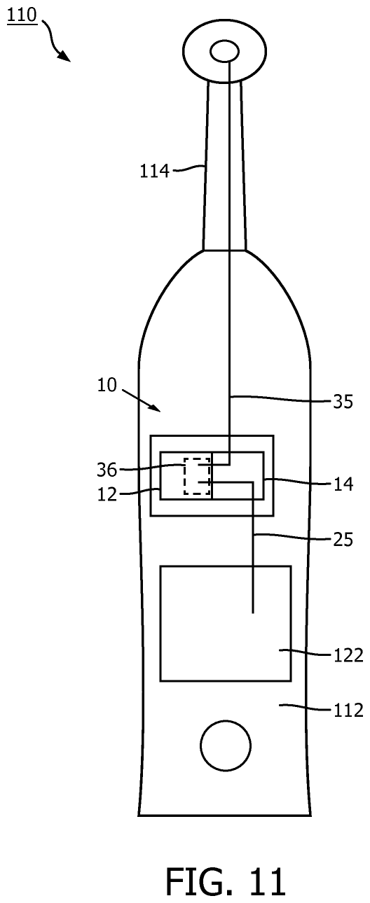

Referring to FIG. 11, in one embodiment, is an example of one possible type of device, an oral care device 110, that could utilize the pump unit 10 of the present invention. It is to be appreciated that the oral care device 110 could in other embodiments include pump units according to any embodiment disclosed herein. The oral care device 110 includes a body portion 112 and a nozzle member configured to emit liquid, air, and/or other fluids from the device. According to an embodiment, the nozzle member 114 is configured to allow the passage of pressurized fluid from the pump unit 10. When in operation, the pump unit 10 draws fluid from a reservoir 122 into the pressure chamber 36 via the inlet fluid pathway 25 in the manner described above. The pump unit 10 then proceeds to pressurize and pump this pressurized fluid out of the device 110 via the outlet fluid pathway 35, which can be arranged ultimately in fluid communication with the nozzle 114. The valve assembly 14 operates as described above with the leaf valve insert 38 to control the flow of fluid through the device 110. In this way, the pump unit 10 can be used to supply pressurized fluid that enables the device 110 to perform its intended function, e.g., to clean a user's teeth. However, the disclosure is not limited to an oral irrigator and thus the disclosure and embodiments disclosed herein can encompass any fluid pumping device.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

1. A valve assembly comprising:
a first housing part having a first inlet channel and a first outlet channel formed therein;
a second housing part having a second inlet channel and a second outlet channel formed therein, the first and second housing parts secured to each other such that the first inlet channel and the second inlet channel are aligned to define an inlet fluid pathway through the valve assembly, and the first outlet channel and the second outlet channel are aligned to define an outlet fluid pathway through the valve assembly; and
a leaf valve insert arranged at an interface between the first housing part and the second housing part, the leaf valve insert including a base having a plurality of leaves hingedly connected thereto, the plurality of leaves including a first leaf aligned with the inlet fluid pathway and a second leaf aligned with the outlet fluid pathway;
wherein the first leaf is operatively configured to permit fluid flow in the inlet fluid pathway past the first leaf in a first direction while impeding fluid flow through the inlet fluid pathway in a second direction, and the second leaf is operatively configured to permit fluid flow in the outlet fluid pathway past the second leaf in the second direction while impeding fluid flow in the outlet fluid pathway in the first direction, wherein the first direction is generally directed from the first housing part toward the second housing part and the second direction is generally directed from the second housing part toward the first housing part wherein the leaf valve insert is formed from a single sheet of material.

2. (canceled)

3. The valve assembly of claim 1, wherein the leaf valve insert further comprises a third leaf and the valve assembly includes a pressure relief subassembly selectively impeded by the third leaf.

4. The valve assembly of claim 3, wherein the pressure relief subassembly further comprises a biasing member engaged against the third leaf that sets a threshold pressure for opening the third leaf.

5. The valve assembly of claim 4, wherein the pressure relief subassembly further comprises an adjuster plug that is movable with respect to the biasing member to set a spring force exerted by the biasing member on the third leaf.

6. The valve assembly of claim 4, wherein the biasing member is located in a relief chamber and the third leaf permits fluid communication with the relief chamber when the third leaf is opened, and the relief chamber is in fluid communication with the first inlet channel of the first housing part.

7. The valve assembly of claim 1, wherein the base of the leaf valve insert comprises an outer ring or a central hub from which the plurality of leaves extends.

8. The valve assembly of claim 1, wherein the first housing part includes a first recess to receive the second leaf when the second leaf is opened and the second housing part includes a second recess to receive the first leaf when the first leaf is opened.

9. A pump unit comprising a valve assembly according to claim 1, wherein the valve assembly is coupled to a pump assembly.

10. The pump unit of claim 9, wherein the pump assembly includes a pressure chamber in fluid communication with both the inlet fluid pathway and the outlet fluid pathway.

11. The pump unit of claim 10, wherein a single seal is included between the first housing part and the second housing part to seal the inlet fluid pathway, the outlet fluid pathway, and the pressure chamber.

12. The pump unit of claim 10, wherein the pump assembly comprises a piston that is reciprocal within a cylinder to pull fluid into the pressure chamber via the inlet fluid pathway and pump fluid out of the pressure chamber via the outlet fluid pathway.

13. The pump unit of claim 11, wherein the cylinder is integrally formed with the second housing part and the pressure chamber is defined at least partially by the cylinder and the second housing part.

14. An oral care device comprising the pump unit of claim 11, wherein the oral care device comprises a reservoir and a nozzle, the reservoir being in fluid communication with the inlet fluid pathway of the valve assembly to supply fluid to the pressure chamber, and the nozzle is in fluid communication with the outlet fluid pathway such that pressurized fluid pumped by the pump unit is emitted out of the nozzle.
